(19) United States
(12) Patent Application Publication
(10) Pub. No.: US 2005/0087568 A1
(43) Pub. Date: Apr. 28, 2005

(54) Spray bottle

(76) Inventor: Joseph A. Silvaggio, Center Valley, PA (US)

Correspondence Address: RATNERPRESTIA, P O BOX 980, VALLEY FORGE, PA, 19482-0980, US

(21) Appl. No.: 10/695,378

(22) Filed: Oct. 27, 2003

(51) Int. Cl. B67D 5/40

(52) U.S. Cl. 222/383.1

(57) ABSTRACT

A hand held bottle for dispensing fluids in a spray having a reservoir for holding fluid and a dispensing mechanism including a siphon tube disposed in the fluid, a first baffle positioned in the bottle to create a well or accumulation of fluid in a bottom portion of the bottle when it is moved from a vertical to a horizontal position, especially when the total level of fluid in the reservoir is low. A second baffle positions the siphon tube within the well.

### BACKGROUND OF THE INVENTION

The present invention pertains to spray bottles and in particular, to those spray bottles used to dispense, inter alia, common household cleaning fluids. Spray bottles find numerous uses both domestically and industrially for dispensing a variety of fluids from plain liquids, e.g. water, alcohol, to complex liquid based compounds.

Spray bottles are commonly used in restaurants to dispense a cleaning fluid to clean tables in between uses by successive patrons.

The problem with prior art spray bottles is that when the bottle is held in a horizontal position and there is only a small amount of fluid left in the bottle, the siphoning tube is not immersed into the fluid and the bottle can no longer spray the contents. Thus, with prior art spray bottles there is always fluid left in the bottle that can not be extracted by the normal spray mechanism. At that point the user must either refill the bottle or transfer the contents from one spray bottle to another spray bottle of like fluid.

### BRIEF DESCRIPTION OF THE INVENTION

The present invention pertains to modifying an existing spray bottle by including a baffle in a lower portion of the spray bottle which will create a reservoir or well in the bottle when the bottle is held in a horizontal position. Having the dip or siphon tube of the spray mechanism positioned in the well or secondary reservoir in the bottle will enable the user to extract an additional amount of fluid when the bottle is held horizontally and thus prolong the useful life of a given spray bottle.

Thus in a broadest aspect the present invention is a device for dispensing fluids from a spray bottle of the type including a liquid reservoir in the form of a bottle adapted to be gripped by a users hand and a spray mechanism including a dip or siphon tube extending into fluid contained in the reservoir, the improvement comprising: first means disposed proximate a bottom surface of the reservoir to trap a quantity of fluid and prevent the quantity of fluid from spreading along a vertical wall of the reservoir when the reservoir is moved from a vertical to a horizontal position by a user, and the siphon tube is positioned so that an inlet end of said siphon tube is below and proximate the first means.

### BRIEF DESCRIPTION OF THE DRAWING

FIG. 1 is a front view partially in section of a spray bottle according to the prior art.

FIG. 2 is a front view partially in section of the spray of FIG. 1 shown in a horizontal position.

FIG. 3 is a partial cross sectional view of the apparatus according to the present invention.

FIG. 4 is a section taken along lines 4-4 of the FIG. 1.

FIG. 5 is a representation of a bottle according to the present invention, partially in perspective, shown disposed in a vertical position during use.

FIG. 6 is a partial perspective view of a bottle according to the present invention shown held in a horizontal position for dispensing fluid.

FIG. 6A is a partial perspective view of a bottle according to the present invention shown held in a horizontal position showing the effect of the features of the invention.

### DETAILED DESCRIPTION OF THE INVENTION

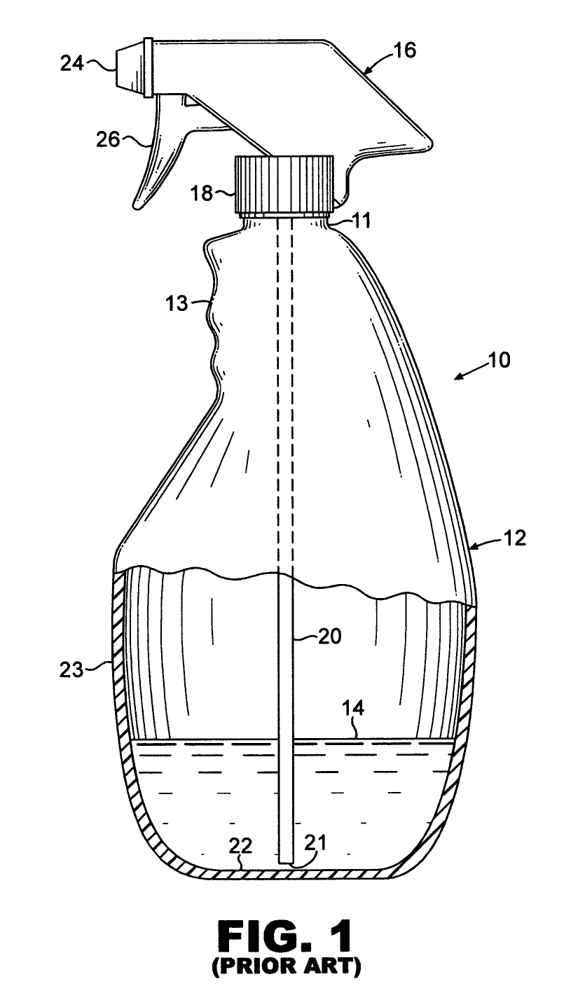

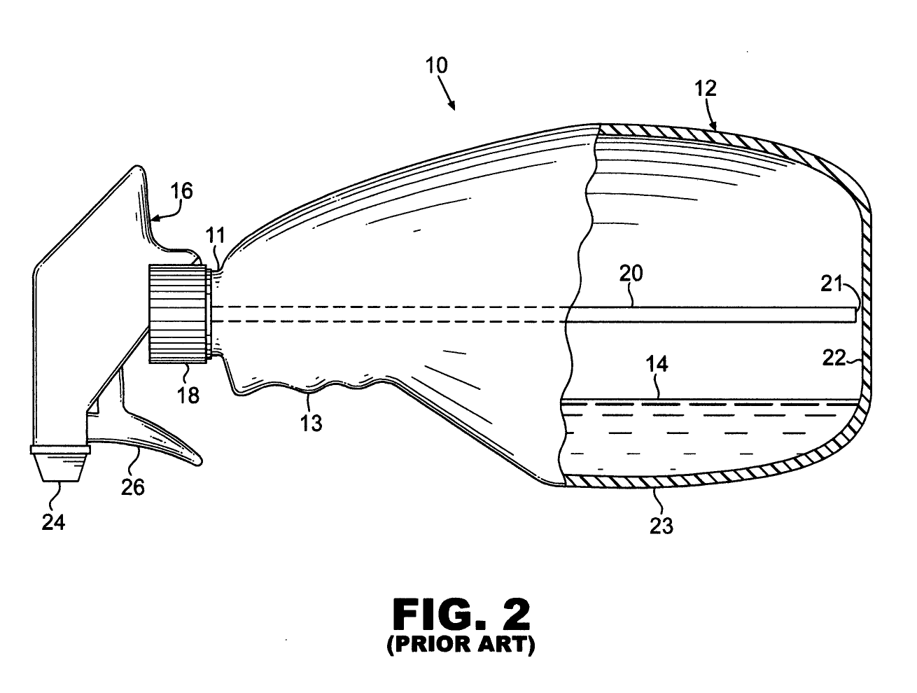

A spray bottle shown generally as 10 in FIGS. 1 and 2 according to the prior art comprises a bottle or reservoir portion 12 which will hold a fluid 14 to be dispensed from the bottle 12 by a spray or pump mechanism 16 which usually is included in a cap 18 closing the neck portion 11 of the bottle 12. Bottle 12 can be made in any convenient shape such as shown in FIG. 1 wherein an upper portion 13 of bottle 12 has the general shape of a pistol grip. The spray mechanism 16 includes a dip or siphon tube 20 that extends toward the bottom 22 of the bottle 12 so that the fluid 14 inside the bottle 12 can be pumped, by activating trigger 26, through the siphon tube 20 to a spray nozzle 24 for dispensing. In prior art bottles the siphon tube is generally vertical and extends to a location proximate the bottom 22 of the spray bottle 12 as shown in FIG. 1. When the spray bottle 12 is held in a vertical position almost all of the liquid can be dispensed using the spray mechanism 16. However, as shown in FIG. 2 when there is only a small amount of fluid 14 left in the bottle 12 and the bottle 12 is tilted or disposed in a horizontal position the fluid 14 is directed away from the siphon tube 20 and cannot be dispensed. This is particularly critical in applications where cleaning and disinfecting fluid is to be sprayed on a horizontal surface such as on a food preparation or food service counter, table top, or other horizontal surface, while the user is generally in a vertical position. As shown in FIG. 2 the fluid moves toward a front wall 23 of the bottle 12, thus leaving the end 21 of siphon tube 20 no longer submerged in fluid 14. In this position the spray mechanism will withdraw air from the bottle 12, not the fluid 14.

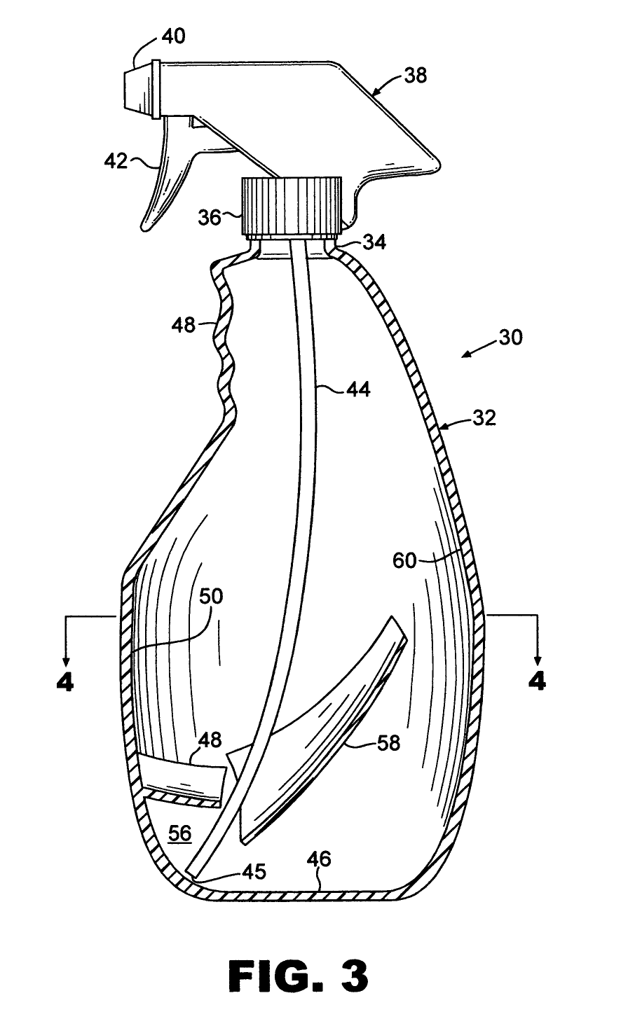

Referring to FIG. 3, the present invention illustrated generally by numeral 30 includes a bottle or reservoir portion 32 having a neck portion 34 closed by a cap or other closure mechanism 36. As with the device of FIG. 1 and FIG. 2 cap 36 is fitted with a pump spray mechanism 38 which includes a nozzle 40 and a trigger or activator device 42. Spray mechanism 38 includes a siphon or dip tube 44, which extends from the dispensing mechanism 38 to a location proximate a bottom portion 46 of bottle 32.

Bottle 32 may also include a grip shaped portion 48 to facilitate holding and spraying of the bottle contents by a user, as is well known in the art.

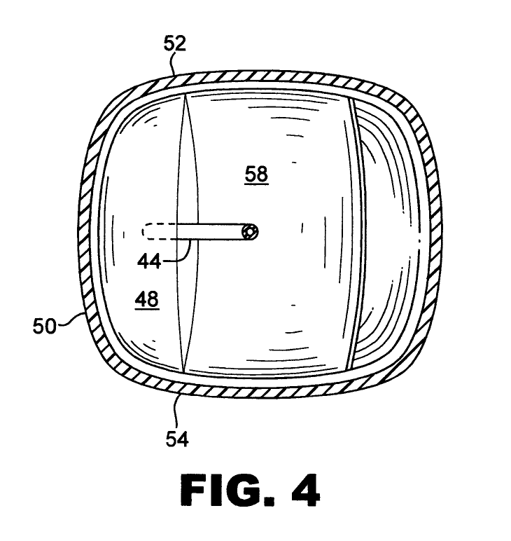

As shown in FIG. 3, the bottle 32 according to the present invention is provided with a first baffle 48, which is formed as part of, or is attached a front wall 50 of the bottle 32 and as shown in FIG. 4 extends between sidewalls 52 and 54 of bottle 32. Baffle 48 thus provides a well, reservoir or closed space 56 in a location adjacent the bottom or gravity portion 46 of bottle 32 as will hereinafter be more fully explained.

Bottle 32 also includes a second baffle or diverter 58, which extends between sidewalls 52 and 54 respectively but does not contact either front wall 50 or back wall 60 or bottom 46 of bottle 32. The baffle 58 serves to assure positioning of the siphon tube 44 within the area 56 when the bottle is filled with fluid and the spray mechanism 38 is in place. Baffle 58 in such that fluid can flow into all interior areas of bottle 32 unimpeded.

Baffle 58 may not be necessary if the siphon tube 44 can be shaped as shown in FIG. 3 and positioned by spray mechanism 38 so that end 45 of siphon or dip tube 44 is below baffle 48 and adjacent wall 50 of bottle 32. Baffle 58 will assure proper positioning of the siphon tube 44 when spray mechanism 38 is placed on bottle 32.

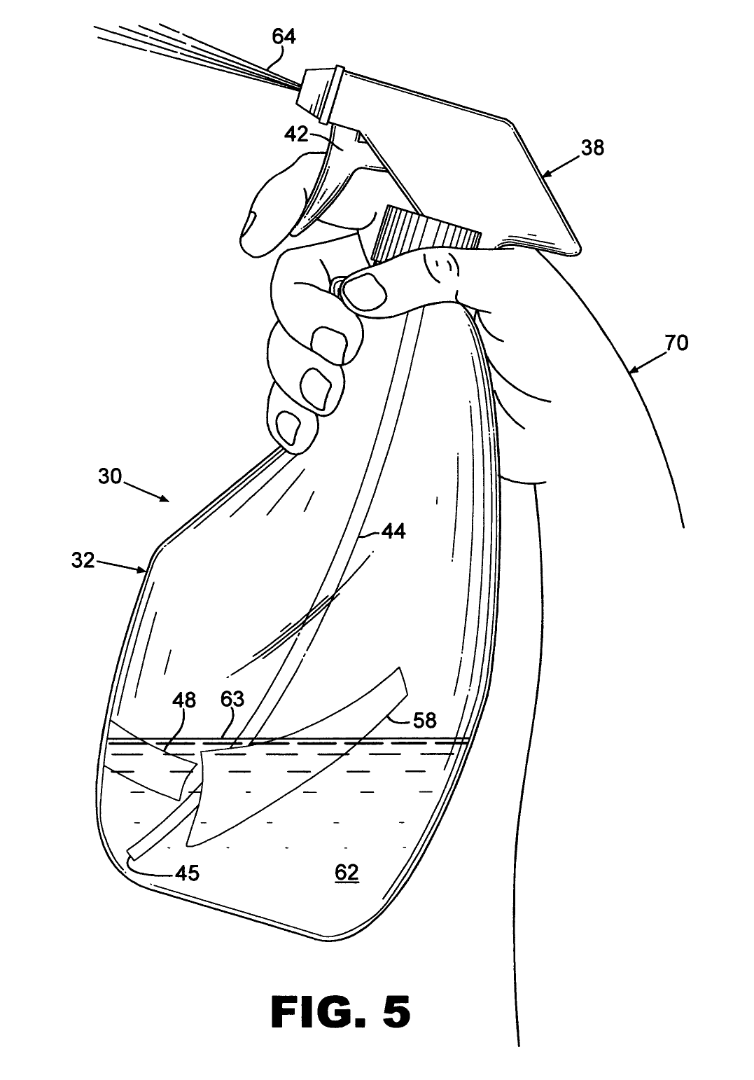

Referring to FIG. 5, the apparatus 30 of the present invention is shown with fluid 62 contained in bottle 32 with a fluid level indicated at 63 that is above the baffle 48 and partially below baffle 58. In this position when a user, represented by the hand 70, is holding the bottle 32 in a vertical or near vertical position the fluid 62 in the form of a spray 64 can be readily dispensed from the bottle 32.

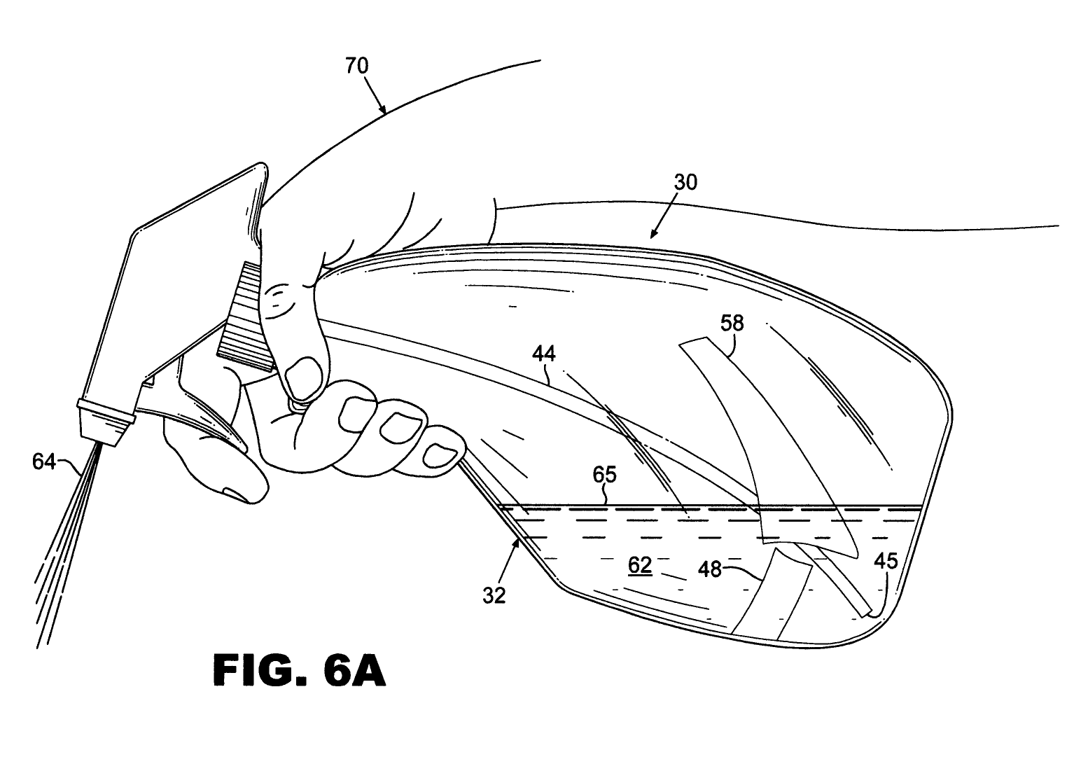

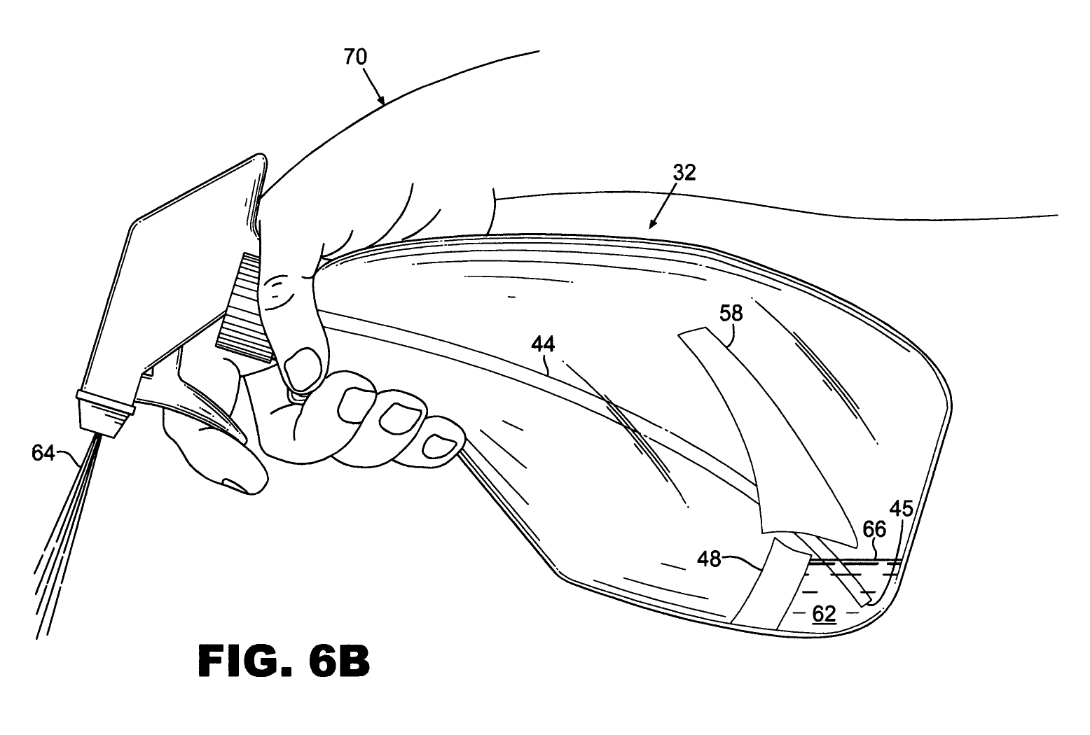

Referring to FIG. 6A, when the user 70 moves the bottle 32 to a generally horizontal position and there is adequate fluid represented by level 65 in the bottle 32, fluid still is able to enter the end 45 of the dip tube 44, thus the user can dispense a spray 64 when bottle 32 is in a generally horizontal position.

Referring to FIG. 6B when the bottle 32 is held in a generally horizontal position by a user 70 and fluid 62 has been withdrawn to a level 66 that would ordinarily prevent the siphon tube 44 from being submerged in the fluid 62, the remaining fluid 62 can be trapped behind baffle 48 by tilting the bottle approximately 180° from the position shown in FIG. 6B toward the user. Thus, the fluid 62 is collected in a secondary well or reservoir of fluid in the area shown as 56 in FIG. 3. When the bottle 32 is rotated back to the position shown in FIG. 6B the entry end 45 of the dip tube 44 is immersed in the remaining fluid 62, thus permitting the user to dispense a spray 64 when bottle 32 is in a horizontal position and most of the fluid 62 has been dispensed.

The baffles 48, 58 according to the present invention virtually eliminate the formation of an air pocket within dip, siphon or suction tube 44 which will necessitate a user moving the bottle to an upright position prior to being able to continue to spray liquid when the liquid level in the bottle is such that it is partially below the entry 45 of dip tube 44.

The secondary baffle 58 assures that the entry end 45 of the dip tube 44 is always immersed in the fluid 62 so that an air pocket does not form within dip tube 44.

The baffles 48, 58 can be conveniently molded in place as the bottle is produced from any of the well known plastic materials used for spray bottles.

While the invention has been shown with a spray bottle of the type that has a generally rectangular or round corner rectangular cross section the invention can be applied to any shape of spray bottle, be they of a square cross section or circular in cross section or in any other shape that one would find convenient to manufacture a spray bottle.

Having thus described my invention what is desired to be secured by Letters Patent of the United States is set forth in the appended claims.

1. In a device for dispensing a fluid spray of the type including a liquid reservoir in the form of a bottle adapted to be gripped by a users hand and a spray mechanism including a dip or siphon tube extending into fluid contained in said reservoir, the improvement comprising: first means disposed proximate a bottom surface of said reservoir to trap a quantity of fluid and prevent said quantity of fluid from spreading along a vertical wall of said reservoir when said reservoir is moved from a vertical to a horizontal position by a user, and said siphon tube positioned so that an inlet end of said siphon tube is below and proximate said first means.

2. A device according to claim 1 including a second means to maintain said siphon tube with its inlet below said first means and adjacent said bottom surface of said reservoir when said siphon tube is inserted into said reservoir and when said reservoir is in a vertical or horizontal position or a position in between vertical and horizontal.

3. A device according to claim 1 wherein said first means is a baffle fixed to vertical wall of said reservoir and so constructed and arranged to form a well or second fluid reservoir within said reservoir to trap a quantity of fluid when said reservoir is held in a horizontal position.

4. A device according to claim 2 wherein said second means is a baffle fixed to walls of said reservoir said baffle so constructed and arranged to intercept and position said siphon tube as it enters said reservoir and to permit fluid in said reservoir to flow into said well or second fluid reservoir.

5. A device according to claim 1 wherein said reservoir is a bottle.

6. A device according to claim 1 wherein said reservoir is a bottle having a portion adapted to be gripped by a user.

7. A device according to claim 6 wherein said bottle has said portion proximate an opening to receive and position said spray mechanism.

8. A device according to claim 7 wherein said spray mechanism is trigger activated.
